(19) United States
(12) Patent Application Publication
(10) Pub. No.: US 2013/0322018 A1
(43) Pub. Date: Dec. 5, 2013

(54) HEAT DISSIPATING MODULE AND SERVER CABINET USING SAME

(71) Applicant: HON HAI PRECISION INDUSTRY CO., LTD., New Taipei (TW)

(72) Inventor: FENG-CHI YANG, New Taipei (TW)

(73) Assignee: HON HAI PRECISION INDUSTRY CO., LTD., New Taipei (TW)

(21) Appl. No.: 13/863,903

(22) Filed: Apr. 16, 2013

(30) Foreign Application Priority Data
May 30, 2012 (CN) 201210171882.9

(51) Int. Cl. G06F 1/20

(52) U.S. Cl. CPC G06F 1/206
USPC 361/695

(57) ABSTRACT

A heat dissipating module is mounted on a server cabinet with several servers and a door and includes a first fan module, a second fan module, a switch module, and a control module. The second fan module is mounted on the door and is aligned with a front end of the server cabinet when the door is closed. The switch module is mounted on the door and the server cabinet. The control module is electrically connected to the first fan module, the second fan module, and the switch module. When the door is closed, the switch module is closed, the control module controls the first fan module and the second fan module both to work; when the door is opened, the switch is opened, the control module controls the first fan module to operate at higher speed, while controlling the second fan module to stop working.

### BACKGROUND

1. Technical Field

The present disclosure relates to heat dissipation from server cabinet, and particularly to a server cabinet heat dissipating module and server cabinet using the heat dissipating module.

2. Description of Related Art

A plurality of servers are mounted inside a cabinet, and a plurality of fans are mounted on a back end of the cabinet facing the servers to dissipate heat from servers. With the lengths of servers being designed being longer than before, when the fans dissipate heat from one side of the server, there is not enough airflow to dissipate heat from the other end of the server which is needed to keep the whole server under a desired temperature.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a server cabinet with a heat dissipating module.

FIG. 2 is a schematic, functional diagram of the heat dissipating module of FIG. 1.

FIG. 3 is a door detecting circuit of the heat dissipating module of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one”.

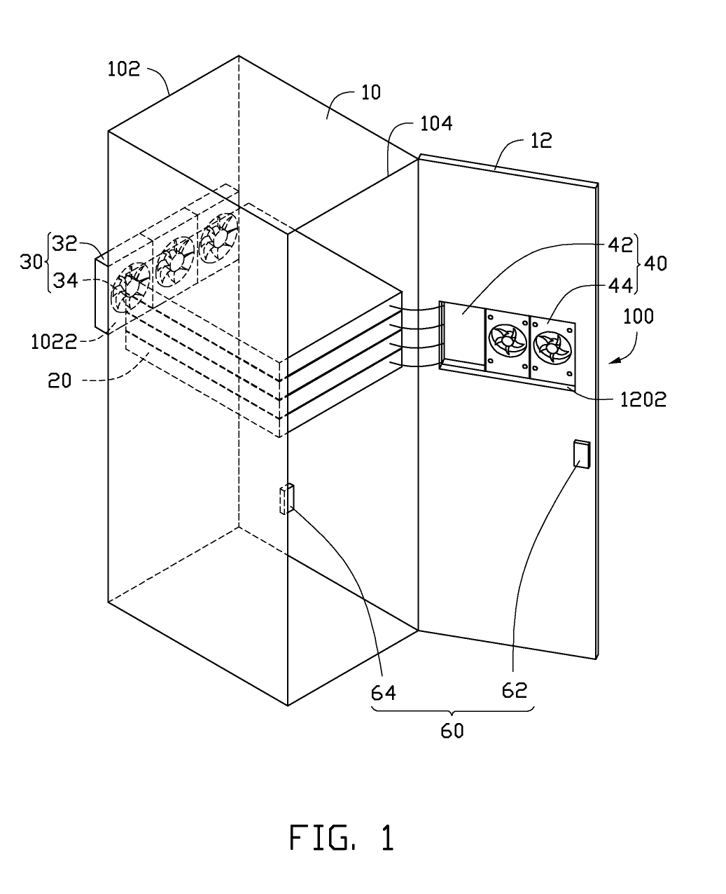

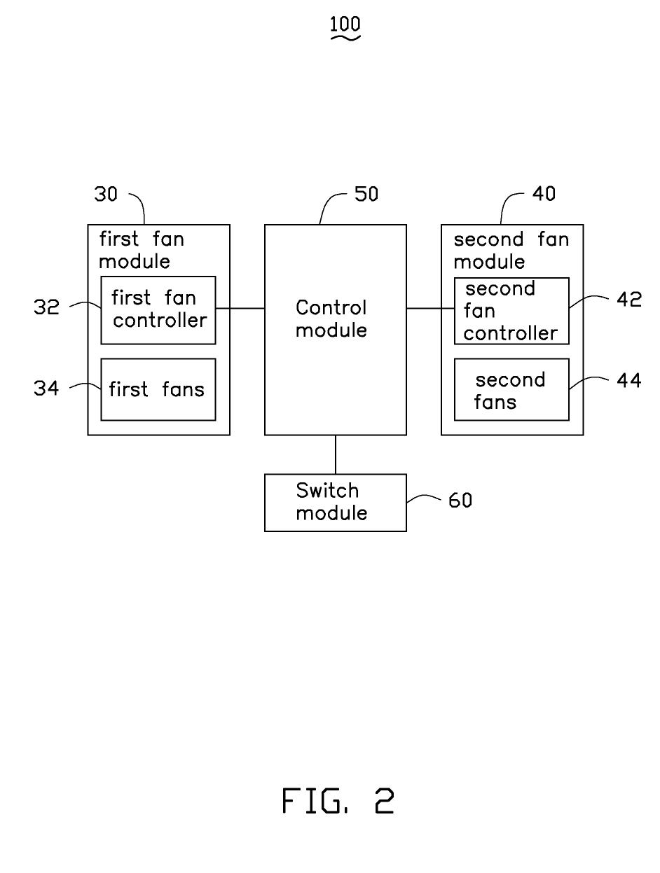

FIG. 1 is an exploded, isometric view of an exemplary embodiment of a server cabinet 10. The server cabinet 10 includes a heat dissipating module 100. A plurality of servers 20 are mounted inside the server cabinet 10. In the present embodiment, the plurality of servers 20 are 4U (Unit, external size of server, 1U=4.445 cm) standard servers. The server cabinet 10 includes a back end 102 and a front end 104. A door 12 is assembled to the front end 104 of the server cabinet 10. The heat dissipating module 100 includes a first fan module 30, a second fan module 40, a control module 50 (shown in FIG. 2), and a switch module 60. The first fan module 30 is mounted on the back end 102 of the server cabinet 10 and dissipates heat from the 4U servers 20. The second fan module 40 is mounted on the door 12, and when the door 12 is closed, the second fan module 40 is aligned with the front end 104 of the server cabinet 10 and dissipates heat from the 4U servers 20. The control module 50 is mounted inside the servers 20 and is electrically connected to the first fan module 30 and the second fan module 40 respectively. The control module 50 controls the first fan module 30 and the second fan module 40. The switch module 60 is mounted on the door 12 and the server cabinet 10 corresponding to the door 12, and the switch module 60 detects the door 12 status of opened or closed.

FIG. 2 is a schematic functional diagram of the heat dissipating module 100 shown in FIG. 1. FIG. 1 and FIG. 2 show that the first fan module 30 includes a first fan controller 32 and first fans 34. A first opening 1022 is defined in the back end 102 of the server cabinet 10, the first fans 34 are mounted on the first opening 1022, the first fan controller 32 is mounted on the first fans 34. The first fan controller 32 is electrically connected to a mainboard of the servers 20 and the first fans 34, and the first fan controller 32 gets working power from the mainboard of the servers 20 and controls the first fans 34. The first fans 34 generate an exhaust airflow to the servers 20 to dissipate heat from the back end of the servers 20.

A second opening 1202 is defined in the door 12. The second fan module 40 includes a second fan controller 42 and second fans 44. The second fan controller 42 and second fans 44 are mounted next to each other on the second opening 1202. The second fan controller 42 is electrically connected to the mainboard of the servers 20 and the second fans 44 respectively, the second fan controller 42 gets working power from the mainboard of the servers 20 and controls the second fans 44. When the door 12 is closed, the second fans 44 generate an exhaust airflow to the servers 20 to dissipate heat from the front end of the servers 20.

The control module 50 is electrically connected to the first fan controller 32 and the second fan controller 42. The control module 50 detects the speed of the first fans 34 and second fans 44 through the first fan controller 32 and the second fan controller 42, and transmits control signals to the first fan controller 32 and the second fan controller 42 to control the first fans 34 and the second fans 44 respectively. In the present embodiment, the control module 50 is combined with an Intelligent Platform Management Interface (IPMI) of a Baseboard Management Controller (BMC) of the servers 20, thus the control module 50 detects and controls the speed of the first fans 34 and the second fans 44. The control module 50 further includes a detecting portion 51 for detecting a logic state of the control module 50.

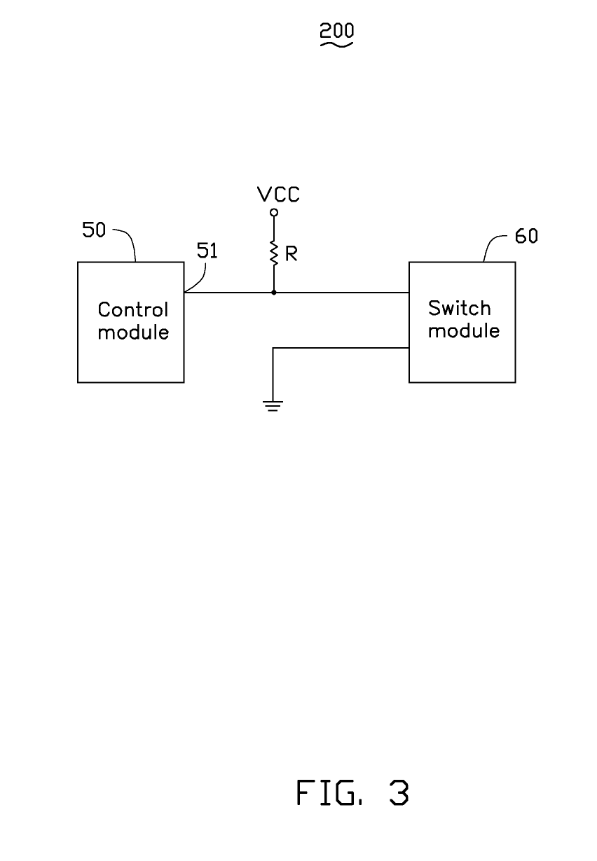

FIG. 3 is a door detecting circuit 200 of the heat dissipating module 100 of FIG. 1. FIG. 1 to FIG. 3 show that the switch module 60 is electrically connected to the control module 50 and the connection of the control module 50 and the switch module 60 forms a door detecting circuit 200. One end of the switch module 50 is connected to ground of the servers 20, the other end is electrically connected to the power Vcc of the servers 20 through a resistor R, the detecting portion 51 of the control module 50 is electrically connected between the switch module 60 and the resistor R.

In the present embodiment, the switch 60 includes a first magnetic member 62 and a second magnetic member 64, the first is magnetic member 62 mounted on the door 12 and the second magnetic member 64 is mounted on the server cabinet 10 at a position to be adjacent to the one mounted on the door 12. When the door 12 is closed and the servers 20 are started, the two magnetic members 62, 64 are attracted together; and the switch module 60 is closed. The control module 50 and the power Vcc are both connected to ground; the detecting portion 51 of control module 50 detects a low (logic 0). The control module 50 is triggered and transmits a first control signal to the first fan controller 32 and the second fan controller 42, the first fan controller 32 and second fan controller 42 control the first fans 34 and second fans 44 to start to operate at normal speed. When one of the first fans 34 or the second fans 44 generate absorbing airflow while the other generate blowing airflow. For example, the airflow is imported from the back end 102 of the server cabinet 10 and moves to the front end 104, and is exported from the front end 104 of the server cabinet 10. Thus, heat dissipation at both ends 102, 104 of the servers 20 is uniform.

When the servers 20 are working and the door 12 is opened, the two magnetic members 62, 64 are separated, and the switch module 60 is opened. The control module 50 is electrically connected to the power Vcc, the detecting portion 51 of the control module 50 detects a high (logic 1). The control module 50 is triggered and transmits a second control signal to the second fan controller 42 to stop the second fans 44, while transmitting a third control signal to the first fan controller 32 to control the first fans 34 to operate at higher speed, thus ensuring heat dissipation of the servers 20. When the first fans 34 generate absorbing airflow while the second fans 44 being an import, or when the first fans 34 generate blowing airflow while the second fans 44 being an export.

When the door 12 is closed again, the two magnetic members 62, 64 are attracted together, and the switch module 60 is closed. The detecting portion 51 of the control module 50 detects the low (logic 0). The control module 50 is triggered and transmits the first control signal to the second fan controller 42 to control the second fans 44 start to operate at normal speed, while transmitting a fourth control signal to the first fan controller 32 to control the first fans 34 to change from high speed to normal speed. The first fans 34 and the second fans 44 act as import and export respectively. Thus, when the servers 20 are working and the door 12 is opened by an operator to check out or maintain the inside of the server cabinet 10, the second fans 44 are moved away from and beyond the reach of the servers 20, the control module 50 stops the second fans 44, which saves the power effectively, while controlling the first fans 34 to operate at higher speed, which ensures heat dissipation of the servers 20.

In addition, the control module 50 detects the speed of the first fans 34 and the second fans 44 through the BMC of the servers 20. When one of the fans is not operating, the control module 50 detects the error and transmits the third control signal to the other end fans controller to control the fans corresponding to the fans controller to operate at higher speed, which ensures heat dissipation of the servers 20.

The heat dissipating module 100 has the first fans 34 and the second fans 44 on the back end and the front end of the servers 20 respectively. The first fans 34 and the second fans 44 generate absorbing and blowing airflow correspondingly, and the airflow moves from one end of the servers 20 to the other. Thus, the heat dissipating module 100 dissipates heat uniformly for the both ends of the servers 20 and achieves a better heat dissipating result.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A heat dissipating module mounted on a server cabinet having a door, the heat dissipating module comprising:
a first fan module, mounted on a first end of the server cabinet;
a second fan module, mounted on the door and aligned with a second end of the server cabinet when the door is closed;
a switch module, having portions mounted on the door and the server cabinet; and
a control module, electrically connected to the first fan module, the second fan module, and the switch module;
wherein when the door is closed, the switch module is closed, the control module controls the first fan module and the second fan module both to work to dissipate heat from the servers; when the door is opened, the switch is opened, the control module controls the first fan module to operate at higher speed, while controlling the second fan module to stop working.

2. The heat dissipating module of claim 1, wherein the first fan module comprises a first fan controller and a plurality of first fans, the first fans are mounted on the first end of the server cabinet, the first fan controller is mounted on the first fans and is electrically connected to a mainboard of the servers and the first fans, the first fan controller controls the first fans.

3. The heat dissipating module of claim 2, wherein the second fan module comprises a second fan controller and a plurality of second fans, the second fan controller and second fans are mounted next to each other on the door, the second fan controller is electrically connected to the mainboard and the second fans, the second fan controller controls the second fans.

4. The heat dissipating module of claim 3, wherein the control module is electrically connected to the first fan controller and the second fan controller and transmits control signals to the first fan controller and the second fan controller to control the speed of the first fans and the second fans.

5. The heat dissipating module of claim 4, wherein one end of the switch module is connected to ground of the mainboard of the servers, the other end is electrically connected to a power of the mainboard of the servers through a resistor.

6. The heat dissipating module of claim 5, wherein the control module includes a detecting portion electrically connected between the switch module and the resistor.

7. The heat dissipating module of claim 6, wherein when the door is closed, the switch module is closed, the detecting portion of the control module detects a low, the control module is triggered and transmits a first control signal to the first fan controller and the second fan controller to control the first fans and the second fans to operate at a predetermined speed.

8. The heat dissipating module of claim 6, wherein when the door is opened, the switch module is opened, the detecting portion of the control module detects a high, the control module is triggered and transmits a second control signal to the second fan controller to control the second fans to stop working, while transmitting a third control signal to the first fan controller to control the first fans to work at a higher speed.

9. The heat dissipating module of claim 8, wherein when the door is closed again, the switch module is closed, the detecting portion of the control module detects the low, the control module is triggered and transmits the first control signal to the second fan controller to control the second fans start to operate at the predetermined speed, while transmitting a fourth control signal to the first fan controller to control the first fans to change from high speed to the predetermined speed.

10. A server cabinet having a door and a heat dissipating module, the heat dissipating module comprising:
a first fan module, mounted on a back end of the server cabinet;
a second fan module, mounted on the door and aligned with a front end of the server cabinet when the door is closed;
a switch module, having portions mounted on the door and the server cabinet; and
a control module, electrically connected to the first fan module, the second fan module and the switch module;
wherein when the door is closed, the switch module is closed, the control module controls the first fan module and the second fan module both to work to dissipate heat from the servers; when the door is opened, the switch is opened, the control module controls the first fan module to operate at higher speed, while controlling the second fan module to stop working.

11. The server cabinet of claim 10, wherein the first fan module comprises a first fan controller and a plurality of first fans, the first fans are mounted on the first end of the server cabinet, the first fan controller is mounted on the first fans and is electrically connected to a mainboard of the servers and the first fans, the first fan controller controls the first fans.

12. The server cabinet of claim 11, wherein the second fan module comprises a second fan controller and a plurality of second fans, the second fan controller and second fans are mounted next to each other on the door, the second fan controller is electrically connected to the mainboard and the second fans, the second fan controller controls the second fans.

13. The server cabinet of claim 12, wherein the control module is electrically connected to the first fan controller and the second fan controller and transmits control signals to the first fan controller and the second fan controller to control the speed of the first fans and the second fans.

14. The server cabinet of claim 13, wherein one end of the switch module is connected to ground of the mainboard of the servers, the other end is electrically connected to a power of the mainboard of the servers through a resistor.

15. The server cabinet of claim 14, wherein the control module includes a detecting portion electrically connected between the switch module and the resistor.

16. The server cabinet of claim 15, wherein when the door is closed, the switch module is closed, the detecting portion of the control module detects a low, the control module is triggered and transmits a first control signal to the first fan controller and the second fan controller to control the first fans and the second fans to operate at a predetermined speed.

17. The server cabinet of claim 15, wherein when the door is opened, the switch module is opened, the detecting portion of the control module detects a high, the control module is triggered and transmits a second control signal to the second fan controller to control the second fans to stop working, while transmitting a third control signal to the first fan controller to control the first fans to work at a higher speed.

18. The server cabinet of claim 17, wherein when the door is closed again, the switch module is closed, the detecting portion of the control module detects the low, the control module is triggered and transmits the first control signal to the second fan controller to control the second fans start to operate at the predetermined speed, while transmitting a fourth control signal to the first fan controller to control the first fans to change from high speed to the predetermined speed.
